(19) United States
(12) Patent Application Publication
(10) Pub. No.: US 2015/0023138 A1
(43) Pub. Date: Jan. 22, 2015

(54) Ultrasonic Positioning System and Method Using the Same

(71) Applicant: Suzhou Touchair Technology Co., Ltd, Suzhou (CN)

(72) Inventors: Guangsong Liu, Suzhou (CN); Shiming Yuan, Suzhou (CN)

(73) Assignee: Suzhou Touchair Technology Co., Ltd, Suzhou (CN)

(21) Appl. No.: 14/283,263

(22) Filed: May 21, 2014

(30) Foreign Application Priority Data
Jul. 22, 2013 (CN) 201310309020.2

(51) Int. Cl. G01S 3/808; H04R 17/00

(52) U.S. Cl. CPC G01S 3/808; H04R 17/005
USPC 367/124

(57) ABSTRACT

Described herein are an ultrasonic positioning system integrated in an electronic device, and a method using the same. The ultrasonic positioning system comprises an ultrasound generator, two or more ultrasound receivers, and a control unit. Said ultrasound generator is configured to generate an ultrasound wave. Said two or more ultrasound receivers are configured to receive a reflected ultrasound wave produced by reflection of the ultrasound wave by an object in a field. Said control unit is configured to determine a position and/or a speed of the object using a frequency shift or a delay or both of the reflected ultrasound wave relative to the ultrasound wave. The ultrasonic positioning system provides gesture recognition and non-contact control of the device based on the ultrasonic positioning function of the device.

### TECHNICAL FIELD

The disclosure herein relates to the field of information processing, and more particularly, to an ultrasonic positioning system, an electronic device with ultrasonic positioning function, and methods of using the same.

### BACKGROUND

In today's information era, various information devices are developed, such as land phones and mobile phones for voice transmission, servers and personal computers for information sharing and processing, various televisions for display of video and data. With the popularization of smart phones, tablet computers and flat screen TVs, human-computer interaction is becoming a new characteristic of these devices in terms of convenience in operation. Presently, although the majority input methods for these devices are still keyboards (such as keyboard based remote controls for TVs), capacitor-based multi-touch screens, new input methods have emerged as well, such as somatosensory input (e.g., Microsoft's Kinetic for XBOX360), voice input (e.g., Apple's Siri), and gesture recognition manipulation (e.g., Samsung's Galaxy series S4 phones). In particular, non-contact gesture recognition control is the main direction of future development.

Currently, gesture recognition control and position tracking technique in consumer electronics are realized mainly through optical methods. For example, the binocular stereo vision technology, the light coding ranging technology of PrimeSense in Israel, and the ToF (time of flight) ranging technology.

However, because all these technologies are affected by ambient light to different degrees, their application scope and application environment are limited. Furthermore, the processing of optical signals requires high clock frequency of the processing chip and thus high power consumption.

### SUMMARY

Disclosed herein is a device comprising: a sound generator configured to generate ultrasonic sound and audible sound; at least two sound receivers configured to detect ultrasonic sound and audible sound.

According to an embodiment, the device further comprises a processor.

According to an embodiment, the processor is configured, to measure frequencies of the ultrasonic sound detected by the at least two sound receivers, to measure a delay between the ultrasonic sound detected by the at least two sound receivers, to drive the sound generator with an electric signal, or to do a combination thereof.

According to an embodiment, the ultrasonic sound generated by the sound generator comprises one or more pulses, at least two different frequencies, or both.

According to an embodiment, the ultrasonic sound detected by the at least two sound receivers comprises at least a portion, a reflected portion, a refracted portion, a diffracted portion or their combination, of the ultrasonic sound generated by the sound generator.

According to an embodiment, the sound generator comprises one or more electro dynamic speakers operable to directly generate air movement, or wherein the sound generator comprises one or more piezoelectric speakers.

According to an embodiment, the sound generator comprises an organic piezoelectric material, an inorganic piezoelectric material, or both.

According to an embodiment, the at least two sound receivers comprise an electret condenser microphone, a microelectromechanical microphone, an ultrasonic transducer comprising a piezoelectric material, or a combination thereof.

According to an embodiment, the device comprises a phone, a computer, a tablet, a personal digital assistance (PDA), a television, a computer monitor, a watch, a video game console, a head-mounted display, a wearable electronic device, or a combination thereof.

Disclosed herein is a device comprising: an image display; a first film of a first piezoelectric material; wherein the first film of the piezoelectric material is configured to generate ultrasonic sound by vibrating the image display.

According to an embodiment, the first film is in front of the display.

According to an embodiment, the first film is disposed on a first portion of the image display, wherein the device further comprises a second film of a second piezoelectric material disposed on a second portion of the image display.

According to an embodiment, the device further comprises a circuit configured to drive the first film by applying an alternating electric voltage across the first film, or further comprising a circuit configured to drive the first film with a first alternating electric voltage across the first film and configured to drive the second film with a second alternating electric voltage across the second film.

According to an embodiment, the device further comprises at least two sound receivers configured to detect ultrasonic sound.

According to an embodiment, the device comprises a phone, a computer, a tablet, a personal digital assistance (PDA), a television, a computer monitor, a watch, a video game console, a head-mounted display, a wearable electronic device, or a combination thereof.

Disclosed herein is a method of using a device, the device comprising an image display, a sound generator and at least two sound receivers, the method comprising: generating ultrasonic sound using the sound generator; detecting a portion, reflection, diffraction, refraction or their combination, of the ultrasonic sound, using the at least two sound receivers; wherein the sound generator is configured to generate audible sound and the at least two sound receivers are configured to detect audible sound.

According to an embodiment, the image display, the sound generator and the at least two sound receivers are in a same enclosure of the device.

According to an embodiment, the method further comprises generating audible sound using the sound generator, detecting audible sound using the at least two sound receivers, or both.

According to an embodiment, generating ultrasonic sound comprises generating one or more pulses of ultrasonic sound, generating at least two frequencies of ultrasonic sound, or both.

According to an embodiment, the method further comprises determining frequencies, time delay, frequency spectra, waveform of sound detected by the at least two sound receivers.

### BRIEF DESCRIPTION OF FIGURES

FIG. 1 is a schematic diagram of the ultrasonic positioning system according to an embodiment.

FIG. 2 is a schematic diagram of an application of an embodiment in mobile phones; wherein 11, 12 and 13 are ultrasound receivers, and 21 is an ultrasound generator in the form of an electro dynamic speaker.

FIG. 3 is a schematic diagram of an application of an embodiment in mobile phones; wherein 11, 12 and 13 are ultrasound receivers, and 21 is an ultrasound generator in the form of a piezoelectric material unit behind an image display.

FIG. 4 is a schematic diagram of an application of an embodiment in mobile phones; wherein 11, 12 and 13 are ultrasound receivers, and 21 is an ultrasound generator in the form of a transparent PVDF piezoelectric film material at a front surface of an image display.

FIG. 5 is a schematic diagram of an application of an embodiment in tablet computers; wherein 11, 12 and 13 are ultrasound receivers, and 21 is an ultrasound generator in form of an electro dynamic speaker.

FIG. 6 is a schematic diagram of an application of an embodiment in tablet computers; wherein 11, 12 and 13 are ultrasound receivers, and 21 is an ultrasound generator in form of a piezoelectric material unit behind an image display.

FIG. 7 is a schematic diagram of an application of an embodiment in tablet computers; wherein 11, 12 and 13 are ultrasound receivers, and 21 is an ultrasound generator in form of a transparent PVDF piezoelectric film material at a front surface of an image display.

FIG. 8 is a schematic diagram of an application of an embodiment in flat screen TVs; wherein 11, 12 and 13 are ultrasound receivers, and 21 is an ultrasound generator in form of an electro dynamic speaker.

FIG. 9 is a schematic diagram of an application of an embodiment in flat screen TVs; wherein 11, 12 and 13 are ultrasound receivers, and 21 is an ultrasound generator in form of a piezoelectric material unit behind an image display.

FIG. 10 is a schematic diagram of an application of an embodiment in flat screen TVs; wherein 11, 12 and 13 are ultrasound receivers, and 21 is an ultrasound generator in form of a transparent PVDF piezoelectric film material at a front surface of an image display.

### DETAILED DESCRIPTION

The current disclosure provides an ultrasonic positioning system in an electronic device, which has a wide scope of application.

Embodiments of this disclosure may include:

Disclosed herein is an ultrasonic positioning system integrated in an electronic device, which includes an ultrasound generator, two or more ultrasound receivers, and a control unit;

said ultrasound generator is configured to produce an ultrasound wave;
said two or more ultrasound receivers are configured to receive a reflected ultrasound wave produced by reflection of the ultrasound wave by an object;
said control unit is configured to determine a position and/or a speed of the object using a frequency shift or a delay or both of the reflected ultrasound wave relative to the ultrasound wave.

Said ultrasound generator may include one or more electro dynamic speakers of the electronic device, the electro dynamic speakers being operable to directly generate air movement, thereby producing ultrasound.

Alternatively, the ultrasound generator may include one or more piezoelectric units operable to indirectly generate air movement by causing vibration of an image display of the electronic device, thereby producing ultrasound.

Said one or more piezoelectric units include an inorganic piezoelectric material behind the image display or a transparent organic piezoelectric film material at a front surface of the image display.

Said two or more ultrasound receivers are internal electret condenser microphones of the electronic device, or microelectromechanical microphones, or ultrasonic transducers comprising a piezoelectric material, wherein the piezoelectric material is an organic piezoelectric materials or an inorganic piezoelectric material.

The ultrasonic positioning system further includes a drive circuit, a control unit configured to generate a drive signal to produce the ultrasound wave and configured to feed the drive signal to the drive circuit; said drive circuit is configured to drive the ultrasound generator based on the drive signal to produce the ultrasound wave.

Said ultrasound generator is further configured to produce an audible sound wave. Said two or more receivers are configured to receive a reflected audible sound wave produced by reflection of the audible sound wave by an object.

Said control unit is further configured to generate a command from a pattern recognized in the position and/or change of the speed of the object, and configured to respond to the command or to send the command to a processor of the electronic device.

Disclosed herein is an electronic device with a positioning function, which includes one or more electro dynamic speakers, two or more ultrasound receivers, and a control unit;

said one or more electro dynamic speakers are configured to produce an ultrasound wave;
said two or more ultrasound receivers are configured to receive a reflected ultrasound wave produced by reflection of the ultrasound wave by an object;
said control unit is configured to determine a position and/or a speed of the object using a frequency shift or a delay or both of the reflected ultrasound wave relative to the ultrasound wave.

Said two or more ultrasound receivers are internal electret condenser microphones of the electronic device, or microelectromechanical microphones, or ultrasonic transducers comprising a piezoelectric material, wherein the piezoelectric material is an organic piezoelectric materials or an inorganic piezoelectric material.

The electronic device may be one of the following: a mobile terminal, a desktop computer, a tablet computer, a PDA (personal digital assistant), a laptop computer, a smart TV or a flat screen TV.

Disclosed herein is an electronic device with a positioning function, which includes an image display, one or more piezoelectric units, two or more ultrasound receivers, and a control unit;

said one or more piezoelectric units are operable to indirectly generate air movement by causing vibration of the image display of the electronic device, thereby producing an ultrasound;
said two or more ultrasound receivers are configured to receive a reflected ultrasound wave produced by reflection of the ultrasound wave by an object;
said control unit is configured to determine a position and/or a speed of the object using a frequency shift or a delay or both of the reflected ultrasound wave relative to the ultrasound wave.

Said one or more piezoelectric units include an inorganic piezoelectric material behind the image display or a transparent organic piezoelectric film material at a front surface of the image display.

Said two or more ultrasound receivers are internal electret condenser microphones of the electronic device, or ultrasonic transducers comprising a piezoelectric material, wherein the piezoelectric material is an organic piezoelectric materials or an inorganic piezoelectric material.

The electronic device may be one of the following: a mobile terminal, a desktop computer, a tablet computer, a PDA (personal digital assistant), a laptop computer, a smart TV or a flat screen TV.

From the above disclosed technical schemes, an ultrasonic positioning system integrated in an electronic device may include an ultrasound generator, two or more ultrasound receivers, and a control unit. Said ultrasound generator is configured to produce an ultrasound wave. Said two or more ultrasound receivers are configured to receive a reflected ultrasound wave produced by reflection of the ultrasound wave by an object. Said control unit is configured to determine a position and/or a speed of the object using a frequency shift or a delay or both of the reflected ultrasound wave relative to the ultrasound wave. Therefore, according to the embodiments, an ultrasound generator and ultrasound receivers are integrated into the same electronic device. The device determines the positioning and speed of an object around the electronic device based on ultrasound time delay and Doppler Effect, and provides gesture recognition and non-contact control of the device.

The disclosure does not require additional space in the electronic device (because of using the existing microphone and speaker within the electronic device). The disclosure also allows a reduction of power consumption of the electronic device because of using piezoelectric material based units as ultrasound generator and the high electro-acoustic conversion efficiency of such material. The disclosed embodiment has low cost and better user experience, compared to conventional optical-based gesture recognition methods.

### EXAMPLES

The current disclosure provides an ultrasonic positioning system integrated into an electronic device. The ultrasonic positioning system includes an ultrasound generator and at least two ultrasound receivers. The system determines the positioning and speed of an object around the electronic device based on ultrasound time delay and Doppler Effect, and provides gesture recognition and non-contact control of the device based on the ultrasonic positioning function of the device.

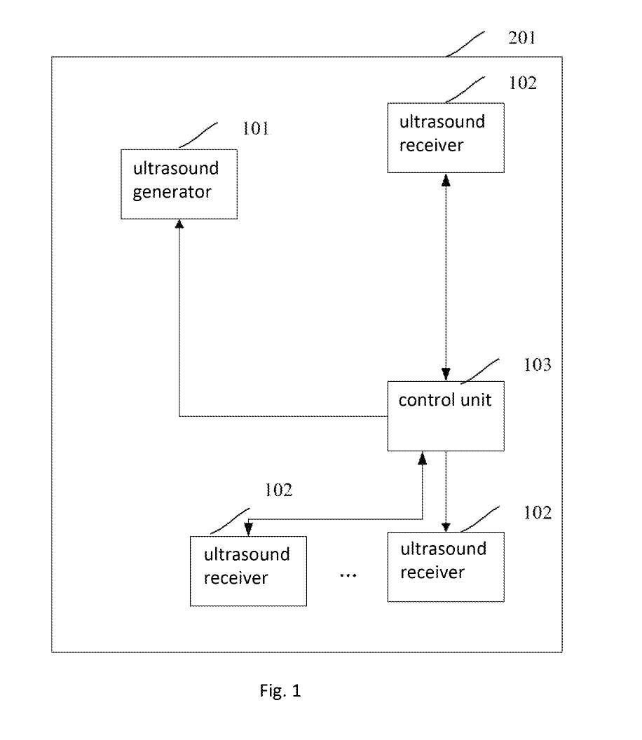

FIG. 1 is a schematic diagram of the ultrasonic positioning system according to an embodiment.

As shown in FIG. 1, an ultrasonic positioning system is integrated in an electronic device 201. The ultrasonic positioning system includes an ultrasound generator 101, two or more ultrasound receivers 102, and a control unit 103.

The ultrasound generator 101 is configured to produce an ultrasound wave.

The two or more ultrasound receivers 102 are configured to receive a reflected ultrasound wave produced by reflection of the ultrasound wave by an object.

The control unit 103 is configured to determine a position and/or a speed of the object using a frequency shift or a delay or both of the reflected ultrasound wave relative to the ultrasound wave.

According to an embodiment, when an object is a hand, the ultrasonic positioning system may realize hand gesture recognition by determining a position and/or a speed of the hand, and non-contact control of the electronic device is realized by hand gesture recognition.

A detailed explanation of the ultrasonic positioning process is as follows.

The ultrasound generator 101 produces an ultrasound wave in a direction, and concurrently a timer starts. The ultrasound wave travels in air, reaches an object, and is reflected by the object as a reflected ultrasound wave. The reflected ultrasound wave travels back. The ultrasound receivers 102 receive the reflected ultrasound wave and concurrently the timer stops.

If the speed of the ultrasound wave traveling in air is v, the time recorded by the timer is t, then the distance (d) between the ultrasound generator and the object is: d=ν×t/2. This is a method of distance measurement based on a measurement of the travel time of a sound wave.

The above method is based on the theory that a sound propagates in the air at a certain speed, therefore an actual distance between an ultrasound generator and an object may be calculated based on time delay between the time of generation of the ultrasound wave and the receiving time of the reflected ultrasound wave reflected by the object.

According to an embodiment with 3 ultrasound receivers, because the location of the ultrasound receivers are known, the spatial coordinate (x, y, z) of an object to be measured can be determined based on the following. The spatial coordinate of an n-th receiver is (Xₙ, Yₙ, Zₙ), and dₙ is the distance between the n-th receiver to the object to be measured.

(x−x₁)²+(y−y₁)²+(z−z₁)²=d₁²

(x−x₂)²+(y−y₂)²+(z−z₂)²=d₂²

(x−x₃)²+(y−y₃)²+(z−z₃)²=d₃²

A theory of measurement of frequency shift from the Doppler-Shift is illustrated as below.

When a sound source and a receiver have relative movement, Doppler-Shift provides that a wavelength of a sound produced by the sound source and a wavelength of the sound received by the receiver have a relationship in correlation with their relative speed of movement. It is assumed that the wavelength of a sound produced by the sound source is λ, the speed of sound traveling in air is c, the relative speed of movement of the sound source and the receiver is v, the relative speed is negative when the sound source and the receiver are getting closer to each other, and the relative speed is positive when the sound source and the receiver are getting further away from each other. Then the frequency of the sound received by the receiver is q, and:

q=(c−ν)/λ.

According to an embodiment, an ultrasound generator may include one or more electro dynamic speakers of the electronic device, the electro dynamic speakers being operable to directly generate air movement, thereby producing ultrasound. Alternatively, the ultrasound generator may include one or more piezoelectric units operable to indirectly generate air movement by causing vibration of an image display of the electronic device, thereby producing ultrasound.

According to an embodiment, said one or more piezoelectric units include an inorganic piezoelectric material behind the image display or a transparent organic piezoelectric film material at a front surface of the image display.

According to an embodiment, said two or more ultrasound receivers are internal electret condenser microphones of the electronic device, or microelectromechanical microphones, or ultrasonic transducers comprising a piezoelectric material, wherein the piezoelectric material is an organic piezoelectric materials or an inorganic piezoelectric material.

Accordingly, the present disclosure provides recognition of an object (for example, a palm or one or more fingers of a person) based on an ultrasonic positioning system and methods using the same. According to an embodiment, ultrasound in the wavelength of 40 KHz to 100 KHz is provided for increased accuracy and reduced interference to the normal hearing range of a person.

The present disclosure provides a combined system for accurate recognition and positioning of a fixed or low speed object based on measurement of ultrasound travel time, and accurate positioning of a high speed object based on the Doppler-Shift.

Additionally, analysis of the characters of movement of the object to be measured can lead to determination of an operation command represented by the movement, and non-contact control of a device.

Preferably, the ultrasonic positioning system further includes a drive circuit.

The control unit is configured to generate a drive signal to produce the ultrasound wave and configured to feed the drive signal to the drive circuit.

The drive unit is configured to drive the ultrasound generator based on the drive signal to produce the ultrasound wave.

According to an embodiment, the ultrasound generator is further configured to produce an audible sound wave.

Preferably, the ultrasound generator can generate a broadband audio signal, with a band width covering audible sound such as between 20 Hz to 20 kHz, and ultrasound such as between 20 kHz to 70 kHz. The ultrasound receivers can receive the broadband audio signal, with a band width covering audible sound such as between 20 Hz to 20 kHz, and ultrasound such as between 20 kHz to 70 kHz.

According to an embodiment, the control unit is further configured to generate a command from a pattern recognized in the position and/or change of the speed of the object, and configured to respond to the command or to send the command to a processor of the electronic device. The control unit can generate a user command from a pattern recognized in the position and/or change of the speed of the object such as a hand of the user, and can respond to the user command in multiple ways, or to send the command to the processor of the electronic device and allow the processor to generate operation response to the user command.

The ultrasonic positioning system disclosed may include a set of ultrasound generators and a set of ultrasound receivers, a set of embedded microcontroller units (MCU) for operation of signal processing software, and MCU-controlled control circuits and MCU-controlled drive circuits.

The ultrasound generators may include one or more electro dynamic speakers of an electronic device, such as a cell phone, to produce ultrasound; or the ultrasound generators may include one or more piezoelectric units, at a front surface of or behind an image display of the electronic device, to generate air movement by causing vibration of the image display, thereby producing ultrasound.

When the ultrasound generators include one or more electro dynamic speakers, the structure and the design of the diaphragm may have optimizations to allow its working frequency range to extend to above 40 kHz, such as adoption of stiffed dome plate composite diaphragm of enhanced strength. Additionally, an optimization in a drive circuit (which is adopted in a microprocessor for control a drive signal and software) may include optimization of the electrical impedance of a coil (because the electrical impedance of a microspeaker in a high frequency range may increase due to the coil inductance, resistance matching or compensation in the drive circuit is beneficial).

When the ultrasound generators include one or more piezoelectric units, the piezoelectric units may be installed behind the image display. Mechanical coupling, such as using a gluing agent, can be provided to transfer the vibration of the piezoelectric units driven by a drive signal to the image display, to generate air movement by causing vibration of the image display (an example is NXT SoundVu), thereby producing ultrasound. In another technical scheme, transparent piezoelectric film materials (such as PVDF films) may be installed at a front surface of the image display, to generate air movement by causing vibration of the image display under a drive signal.

The ultrasound receivers may be internal microphones, such as two or more EMC type or MEMS type internal electret condenser microphones, or piezoelectric unit arrays at a front surface of or behind the image display.

When the ultrasound receivers include internal electret condenser microphones, compared to those microphones used in regular communication, the receiving diaphragm and the preamplifier circuit may have suitable optimizations to allow an extension of its working frequency range to a range not lower than the frequency of the ultrasound generators (e.g., the high frequency cutoff of the working frequency is within 70 kHz to 100 kHz). As most of the smart phones or tablet computers on the market have active noise reduction and stereo recording functions, microphones in these types of devices generally only need an extension of their frequency range.

When the ultrasound receivers include piezoelectric unit arrays at a front surface of or behind the image display, piezoelectric effect is utilized. When a reflected ultrasound wave reaches the image display, a small air pressure or mechanical vibration is triggered, which generates an electric signal in the piezoelectric unit array. Because a spatial interval is needed between the microphones or the piezoelectric units in the array, the array with horizontal or vertical alignment is preferred. Such alignment allows accurate spatial positioning by determination of the three dimensional coordinate of the object from time delays at different receivers and Doppler frequency shift.

The MCU, MCU-controlled drive circuit and receiving circuit, no matter in an integrated circuit or discrete circuits, include the following functional modules: an embedded microprocessor module, which is operable to perform the function of signal generation, signal collection, signal processing, pattern recognition, module controls and CPU communications;

a digital to analog (D/A) converter module, which is operable to convert the digital signal from the microprocessor to an analog signal to drive the ultrasonic drive circuit; usually this module can be integrated within the MCU;
an analog to digital (A/D) converter module, which is operable to convert an analog electrical signal from the ultrasound receiver circuit to a digital signal, to allow processing by the MCU; usually this module can be integrated within the MCU;
a power amplification circuit module for an ultrasonic generating signal, which is operable to amplify the D/A output ultrasound signal to directly drive the ultrasound generator; an amplifying circuit module for an ultrasonic receiving signal, similar to an integrated microphone amplifier, which is operable to amplify a weak electrical signals generated by the ultrasound receivers and make the appropriate filtering; The analog signal generated from this module will be passed through the A/D converter module and transmitted to the MCU in the form of a digital signal.

The present disclosure does not require an increase in the structural space of a device (the ultrasound generator and receivers may reuse the microphones and speakers existing in the device). When the ultrasound generators include one or more piezoelectric units, the power consumption is lowered in the technical scheme because of the high electro-acoustic conversion efficiency. Compared to traditional gesture recognition methods based on optical recognition, the present technical scheme provides advantages such as lower cost and better user experience.

According to an embodiment, an ultrasonic positioning electronic device is provided, which includes one or more electro dynamic speakers, two or more ultrasound receivers, and a control unit. Said one or more electro dynamic speakers are configured to generate an ultrasound wave. Said two or more ultrasound receivers are configured to receive a reflected ultrasound wave produced by reflection of the ultrasound wave by an object. Said control unit is configured to determine a position and/or a speed of the object using a frequency shift or a delay or both of the reflected ultrasound wave relative to the ultrasound wave.

In the electronic device, said two or more ultrasound receivers are internal electret condenser microphones of the electronic device, or microelectromechanical microphones, or ultrasonic transducers comprising a piezoelectric material, wherein the piezoelectric material is an organic piezoelectric materials or an inorganic piezoelectric material.

Exemplary electronic devices may include a mobile terminal, a desktop computer, a tablet computer, a personal digital assistance (PDA), a laptop computer, a smart TV, or a flat screen TV, etc.

According to an embodiment, an ultrasonic positioning electronic device is provided, which includes an image display, one or more piezoelectric units, two or more ultrasound receivers, and a control unit.

Said one or more electro dynamic speakers are configured to generate an ultrasound wave. Said two or more ultrasound receivers are configured to receive a reflected ultrasound wave produced by reflection of the ultrasound wave by an object. Said control unit is configured to determine a position and/or a speed of the object using a frequency shift or a delay or both of the reflected ultrasound wave relative to the ultrasound wave.

Said one or more piezoelectric units are operable to indirectly generate air movement by causing vibration of an image display of the electronic device, thereby producing ultrasound. Said two or more ultrasound receivers are configured to receive a reflected ultrasound wave produced by reflection of the ultrasound wave by an object. Said control unit is configured to determine a position and/or a speed of the object using a frequency shift or a delay or both of the reflected ultrasound wave relative to the ultrasound wave.

In the electronic device, said one or more piezoelectric units include an inorganic piezoelectric material behind an image display or a transparent organic piezoelectric film material at a front surface of the image display.

In the electronic device, said two or more ultrasound receivers are internal electret condenser microphones of the electronic device, or ultrasonic transducers comprising a piezoelectric material, wherein the piezoelectric material is an organic piezoelectric materials or an inorganic piezoelectric material.

Exemplary electronic devices may include a mobile terminal, a desktop computer, a tablet computer, a personal digital assistance (PDA), a laptop computer, a smart TV, or a flat screen TV, etc.

Although exemplary electronic devices are provided above, a person with ordinary skill in the art may know that exemplary electronic devices may include any device that include data processing function and/or communication function, and does not limit the scope of the disclosure.

Further illustrations of the various embodiments are provided below in view of the drawings.

The disclosure provides an embodiment of application in a mobile phone or cell phone as illustrated below.

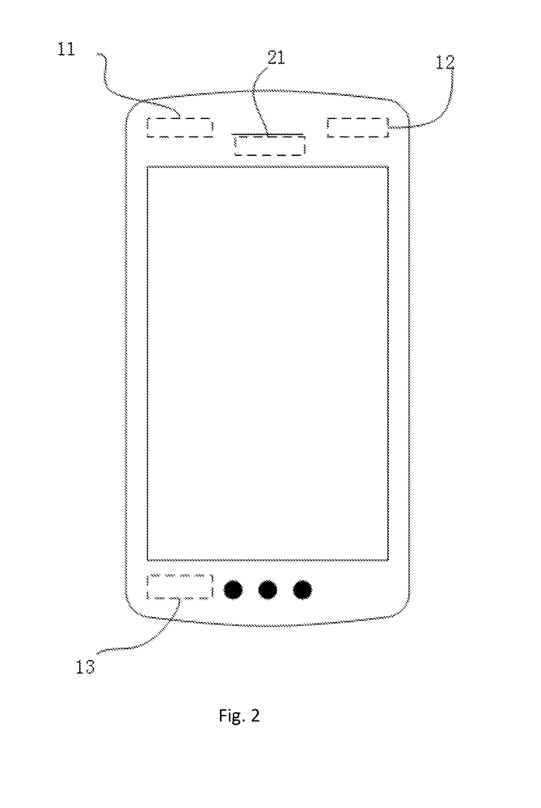

According to an embodiment as shown in FIGS. 2-4, capacitor-based internal electret condenser microphones (ECM microphone) 11, 12, 13 are from the AAC company, and have the parameters of 4 mm diameter, 1.6 mm height, 50 Hz to 40 kHz working frequency range and −32 dBV/Pa typical sensitivity.

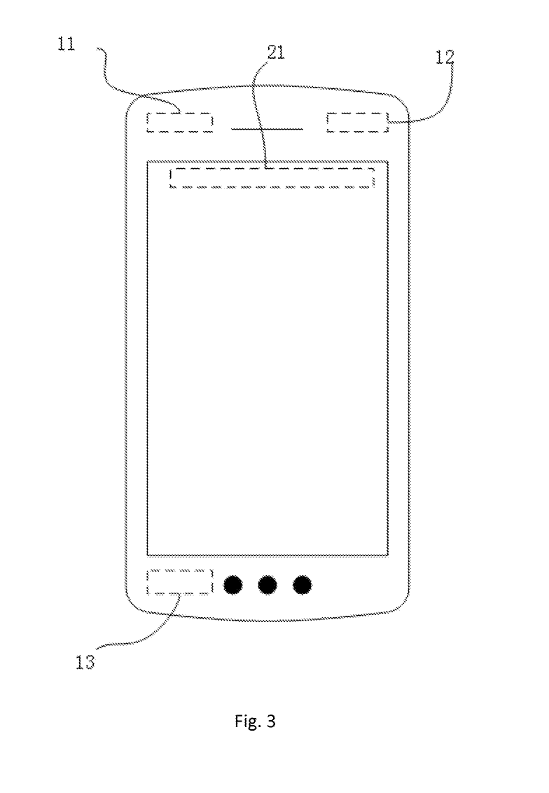

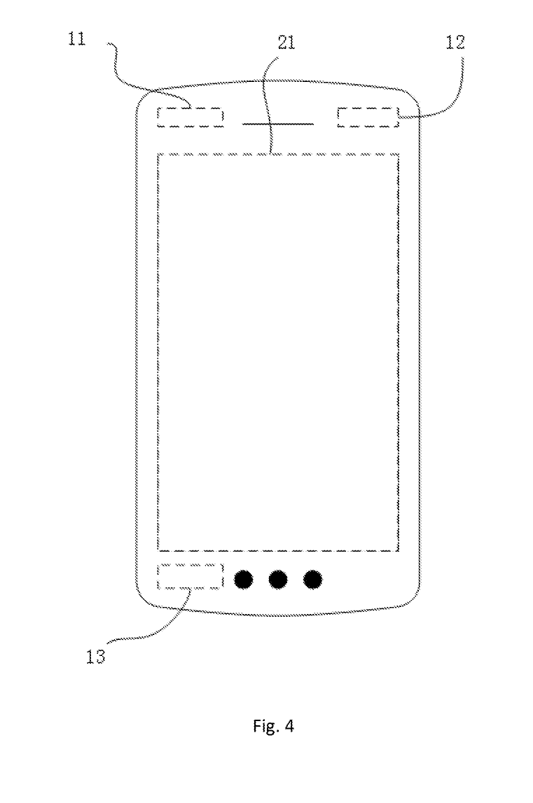

As shown in FIG. 2, an electro dynamic speaker 21 have the parameters of 7 mm×10 mm×2.0 mm, 300 Hz to 40 kHz working frequency range, 105 dBSPL at 1 mW typical sensitivity (tested with an IEC 318 artificial ear). As shown in FIG. 3, a multilayer piezoelectric ceramic panel 21 has dimensions of 5 mm×25 mm×0.1 mm. As shown in FIG. 4, a PVDF film 21 has a thickness of 20 μm.

As shown in FIG. 2-4, ECM microphones 11, 12, 13 are respectively at the top left, top right and bottom left of the cell phone. The ECM microphones 11 and 12 are at the top of an image display of the cell phone, corresponding to an X axis in a coordinate. The ECM microphones 11 and 13 are at the left of the image display of the cell phone, corresponding to a Y axis in the coordinate. ECM microphones 11, 12, 13, the electro dynamic speaker 21 (as shown in FIG. 2), or the multilayer piezoelectric ceramic panel 21 (as shown in FIG. 3), or the PVDF film 21 (as shown in FIG. 4) are each electrically connected to an internal signal amplifier and the drive circuit. An ultrasound wave generated by the microprocessor of the cell phone is sent by the ultrasound drive circuit to the electro dynamic speaker 21, or the multilayer piezoelectric ceramic panel 21, or the PVDF film 21, to generate air movement, thereby producing ultrasound.

When the ultrasound is reflected by an object in the acoustic field, the reflected ultrasound can be received by the three microphones, and converted to an electric signal. Then the time, frequency and phase of the received reflected ultrasound are respectively analyzed, and the spatial position and the relative speed and direction of movement of the object in the field can be determined. Specifically, a time interval between the generation time and receive time of the ultrasound can be determined from the receive time. A distance from the object to the respective microphones 11, 12, 13 can be determined from the following equation, d=ν×t/2; and the spatial coordinate of the object in the field can be determined based on triangulation. Furthermore, the relative speed and direction of movement of the object in the field can be determined from combined analysis of the frequency and phase of the received reflected ultrasound with the Doppler Effect.

Further pattern analysis of the movement of the object within a certain amount of time can lead to determination of the user command represented by the movement, and can be sent to a CPU of the cell phone by the embedded microprocessor.

The disclosure also provides an embodiment of an application in a tablet computer as illustrated below.

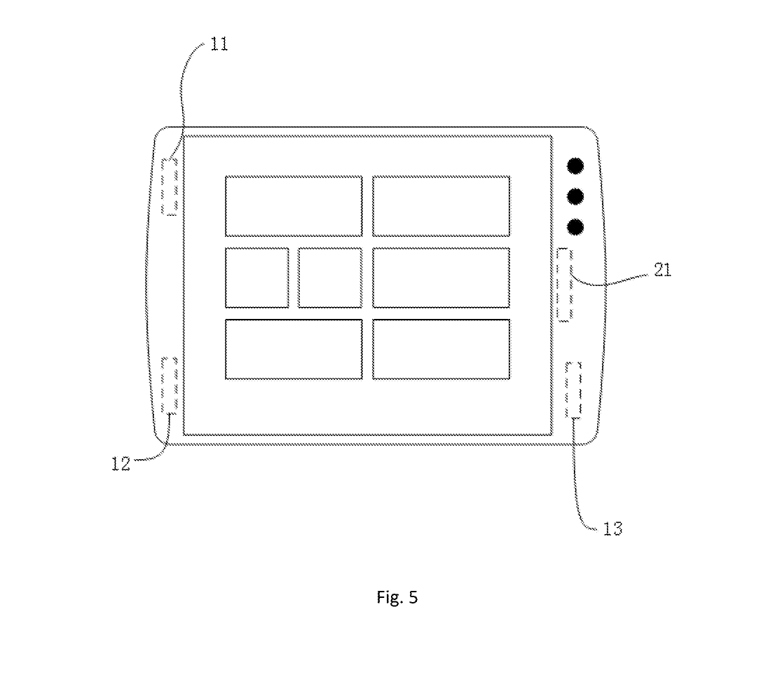

According to an embodiment as shown in FIGS. 5-7, capacitor-based internal electret condenser microphones (ECM microphone) 11, 12, 13 are from the AAC company and have the parameters of 4 mm diameter, 1.6 mm height, 50 Hz to 40 kHz working frequency range and −32 dBV/Pa typical sensitivity.

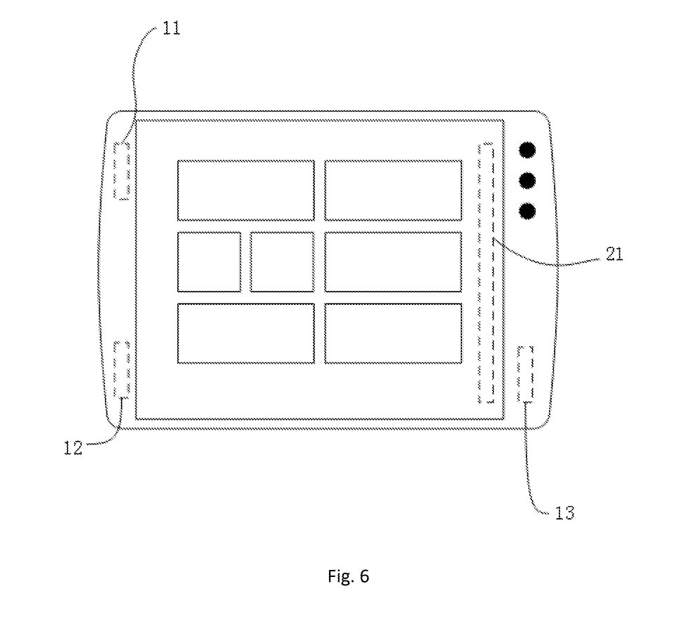

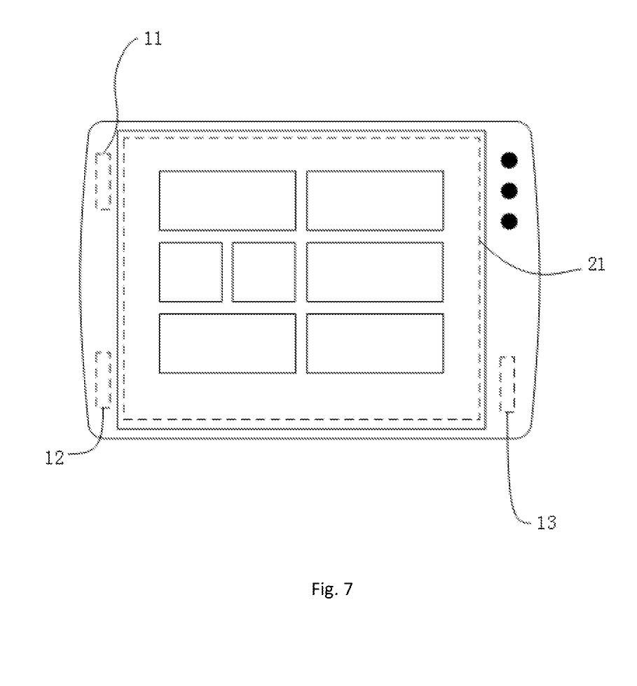

As shown in FIG. 5, an electro dynamic speaker 21 have the parameters of 14 mm×25 mm×3.0 mm, 100 Hz to 40 kHz working frequency range, 75 dBSPL at 1 W/1 m typical sensitivity (under the IEC268 standard). As shown in FIG. 6, a multilayer piezoelectric ceramic panel 21 is 5 mm×50 mm×0.1 mm. As shown in FIG. 7, a PVDF film 21 is 20 μm in depth.

As shown in FIG. 5-7, microphones 11, 12, 13 are respectively at the top left, bottom left and bottom right of an image display of the tablet computer. The microphones 12 and 13 are at the bottom of the image display, corresponding to an X axis in a coordinate. The microphones 11 and 12 are at the left of the image display, corresponding to a Y axis in the coordinate.

ECM microphones 11, 12, 13, the electro dynamic speaker 21 (as shown in FIG. 5), or the multilayer piezoelectric ceramic panel 21 (as shown in FIG. 6), or the PVDF film 21 (as shown in FIG. 7) is each electrically connected to an internal signal amplifier and the drive circuit.

A ultrasound wave generated by the microprocessor of the tablet computer is sent by the ultrasound drive circuit to the electro dynamic speaker 21 (as shown in FIG. 5), or the multilayer piezoelectric ceramic panel 21 (as shown in FIG. 6), or the PVDF film 21 (as shown in FIG. 7), to generate air movement by causing vibration of the image display, thereby producing ultrasound.

When the ultrasound is reflected by an object in the field, the reflected ultrasound can be received by the three microphones, and converted to an electric signal. Then the receive time, frequency and phase of the received reflected ultrasound are respectively analyzed, and the spatial position and the relative speed and direction of movement of the object in the field can be determined. Further pattern analysis of the movement of the object within a certain amount of time can lead to determination of the user command represented by the movement, and can be sent to a CPU of the tablet computer by the embedded microprocessor.

The disclosure also provides an embodiment of an application in a flat screen TV as illustrated below.

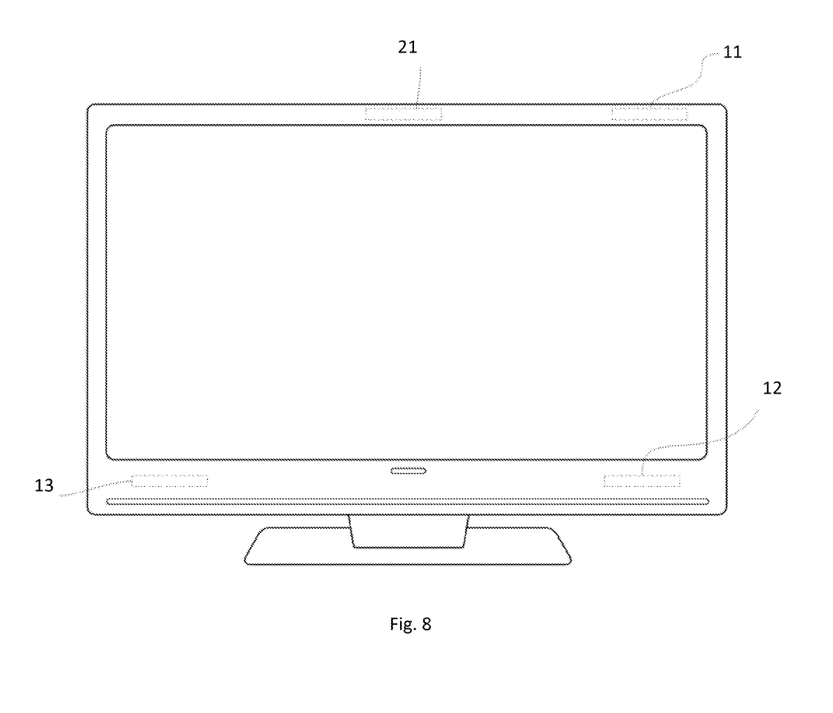

According to an embodiment as shown in FIGS. 8-10, capacitor-based internal electret condenser microphones (ECM microphone) 11, 12, 13 are from the AAC company and have the parameters of 4 mm diameter, 1.6 mm height, 50 Hz to 40 kHz working frequency range and −32 dBV/Pa typical sensitivity.

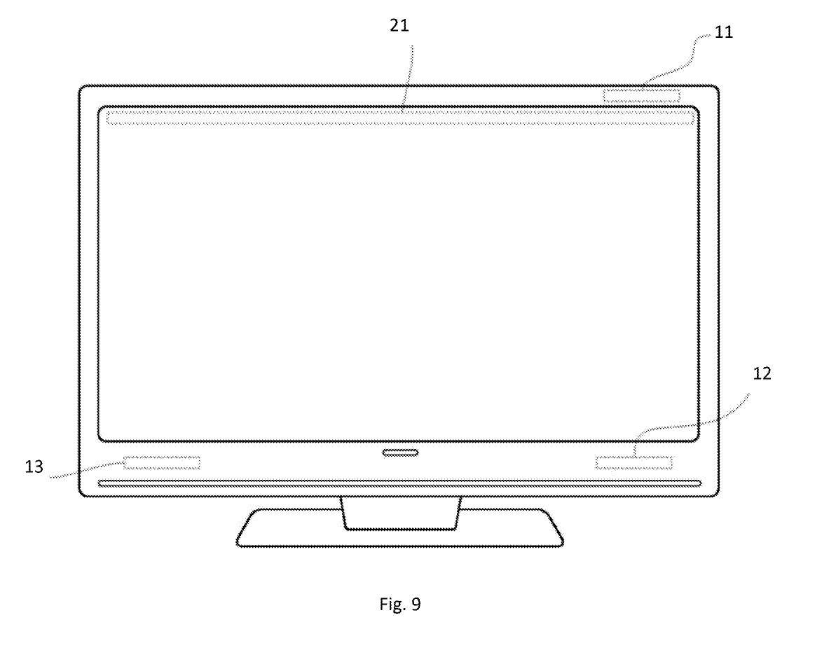

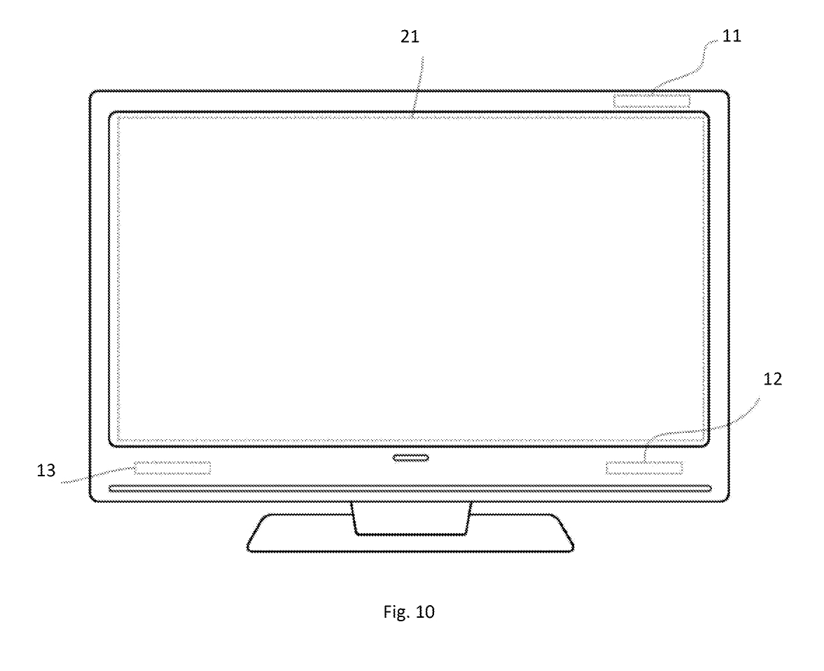

As shown in FIG. 8, an electro dynamic speaker 21 have the parameters of 20 mm×40 mm×4.0 mm, 500 Hz to 40 kHz working frequency range, 80 dBSPL@1 W/1 m typical sensitivity (IEC268 standard). As shown in FIG. 9, a multilayer piezoelectric ceramic panel 21 is 10 mm×80 mm×0.1 mm. As shown in FIG. 10, a PVDF film 21 is 20 μm in depth.

As shown in FIG. 8-10, microphones 11, 12, 13 are respectively at the top right, bottom left and bottom right of an image display of the flat screen TV. The microphones 12 and 13 are at the bottom of the image display, corresponding to an X axis in a coordinate. The microphones 11 and 12 are at the left of the image display, corresponding to a Y axis in the coordinate.

ECM microphones 11, 12, 13, the electro dynamic speaker 21 (as shown in FIG. 8), or the multilayer piezoelectric ceramic panel 21 (as shown in FIG. 9), or the PVDF film 21 (as shown in FIG. 10) is each electrically connected to an internal signal amplifier and a drive circuit.

A ultrasound wave generated by a microprocessor of the tablet computer is sent by the drive circuit to the electro dynamic speaker 21 (as shown in FIG. 8), or the multilayer piezoelectric ceramic panel 21 (as shown in FIG. 9), or the PVDF film 21 (as shown in FIG. 10), to generate air movement by causing vibration of the image display, thereby producing ultrasound.

When the ultrasound is reflected by an object in the field, the reflected ultrasound can be received by the three microphones, and converted to an electric signal. Then the receive time, frequency and phase of the received reflected ultrasound are respectively analyzed, and the spatial position and the relative speed and direction of movement of the object in the field can be determined. Further pattern analysis of the movement of the object within a certain amount of time can lead to determination of the user command represented by the movement, and can be sent to a CPU of the flat screen TV by the embedded microprocessor.

The ultrasonic positioning system disclosed may include a set of ultrasound generators and a set of ultrasound receivers, a set of embedded microcontroller units (MCU) for operation of signal processing software, and MCU-controlled control circuits and MCU-controlled drive circuits.

The ultrasound generators may be adapted to the different application terminals, such as a cell phone or other electronic devices. The ultrasound generators may include one or more electro dynamic speakers operable to directly generate air movement, thereby producing ultrasound; or the ultrasound generators may include one or more piezoelectric units, such as piezoelectric ceramic units or PVDF films, operable to indirectly generate air movement by causing vibration of an image display of the electronic device, thereby producing ultrasound.

The ultrasound receivers may be internal microphones of the application terminals, such as two or more EMC type or MEMS type internal electret condenser microphones, or two or more ultrasonic transducers comprising a piezoelectric material, such as piezoelectric ceramic units or PVDF films.

MCU runs a specific algorithm to generate a drive signal such as a pulse or a modulated and continued ultrasound signal, and is configured to feed the drive signal to a drive circuit; wherein the drive circuit is configured to drive the one or more sets of ultrasound generators to produce the ultrasound wave. When the ultrasound is reflected by an object, such as a palm or fingers of a user in a specific filed, a reflected ultrasound wave is produced by the object. The reflected ultrasound wave may exhibit Doppler Effect due to the movement of the object. Additionally, time delay results from difference between the time of generation of the ultrasound wave and the receiving time of the reflected ultrasound wave reflected by the object. The amount of time delay is determined by the distance between the ultrasound generators and the object, and distance between the object and the ultrasound receivers (assuming that the speed of ultrasound traveling in air is essentially constant). The reflected ultrasound wave is received by the ultrasound receivers, amplified by an amplifier circuit, and sent to a microprocessor. The microprocessor analyze the frequency shift and time delay from signals received by each ultrasound receiver, and combines the analysis to determine the spatial positioning and movement speed of the object in the specific field. After the analysis of object in the specific field for a certain amount of time, pattern analysis can be applied to determine the user command represented by the movements of the object. The user command can be sent to the CPU of the application terminal to effect and realize a specific operation on the application terminal.

According to an embodiment, an ultrasonic positioning device may include a sound generator configured to generate ultrasonic sound and audible sound; and at least two sound receivers configured to detect ultrasonic sound and audible sound.

The device may further include a processor.

The processor may be configured to measure frequencies of the ultrasonic sound detected by the at least two sound receivers, to measure a delay between the ultrasonic sound detected by the at least two sound receivers, to drive the sound generator with an electric signal, or to do a combination thereof.

The ultrasonic sound generated by the sound generator may include one or more pulses, at least two different frequencies, or both. The ultrasonic sound may have frequency-domain and/or time-domain coding. For example, the lengths and intervals of the pulses may be controlled. The ultrasonic sound may have a spread spectrum.

The ultrasonic sound detected by the at least two sound receivers may include at least a reflected portion, a refracted portion, a diffracted portion or their combination, of the ultrasonic sound generated by the sound generator.

The sound generator may include one or more electro dynamic speakers operable to directly generate air movement, or wherein the sound generator comprises one or more piezoelectric speakers.

The sound generator may include an organic piezoelectric material, an inorganic piezoelectric material, or both.

The at least two sound receivers may include an electret condenser microphone, a microelectromechanical microphone, or both.

The device comprises a phone, a computer, a tablet, a personal digital assistance (PDA), a television, a computer monitor, a watch, a video game console, a head-mounted display, a wearable electronic device, or a combination thereof.

According to an embodiment, an ultrasonic positioning device may include an image display; a first film of a first piezoelectric material; wherein the first film of the piezoelectric material is configured to generate ultrasonic sound by vibrating the image display. The first film may be in front of the display. The first film may be disposed on a first portion of the image display. The device may further include a second film of a second piezoelectric material disposed on a second portion of the image display. The device may include multiple portions on which a film of piezoelectric material is disposed. These portions may be independently driven. These portions may function as a phased array. For example, these portions may cooperatively generate directional ultrasound, spatially scan the direction ultrasound wave, focusing the directional ultrasound to an object in the acoustic field, etc.

The device may further include a circuit configured to drive the first film by applying an alternating electric voltage across the first film, or further comprising a circuit configured to drive the first film with a first alternating electric voltage across the first film and configured to drive the second film with a second alternating electric voltage across the second film.

The device may further include at least two sound receivers configured to detect ultrasonic sound.

The device may be a phone, a computer, a tablet, a personal digital assistance (PDA), a television, a computer monitor, a watch, a video game console, a head-mounted display, a wearable electronic device, or a combination thereof.

According to an embodiment, a method of using a device may include: generating ultrasonic sound using a sound generator of the device; detecting reflection, diffraction, refraction or their combination, of the ultrasonic sound, using at least two sound receivers of the device; wherein the sound generator is configured to generate audible sound and the at least two sound receivers are configured to detect audible sound.

An image display of the device, the sound generator and the at least two sound receivers are in a same enclosure of the device.

The method may further include generating audible sound using the sound generator, detecting audible sound using the at least two sound receivers, or both.

Generating ultrasonic sound may include generating one or more pulses of ultrasonic sound, generating at least two frequencies of ultrasonic sound, or both.

The method may further include determining frequencies, time delay, frequency spectra, waveform of sound detected by the at least two sound receivers.

The present disclosure solves the issues associated with traditional gesture recognition methods based on optical systems, such as large energy consumption, bulk size, low resolution, and inclination to interference from the environment. The present disclosure provides advantages such as simplicity in structure, low energy consumption, easy integration into a cell phone, a tablet computer or other mobile devices, high resolution, and accuracy in recognition. Electronic devices with application of the presently disclosed technology, such as a cell phone, a tablet computer, laptop computer, flat screen TV or other devices, will bring a better user experience to consumers.

In relation to the claims, it is intended that when words such as “a,” “an,” “at least one,” or “at least one portion” are used to preface a feature there is no intention to limit the claim to only one such feature unless specifically stated to the contrary in the claim.

The descriptions above are intended to be illustrative, not limiting. Thus, it will be apparent to one skilled in the art that modifications may be made without departing from the scope of the claims set out below.

What is claimed is:

1. A device comprising:
a sound generator configured to generate ultrasonic sound and audible sound;
at least two sound receivers configured to detect ultrasonic sound and audible sound.

2. The device of claim 1, further comprising a processor.

3. The device of claim 2, wherein the processor is configured, to measure frequencies of the ultrasonic sound detected by the at least two sound receivers, to measure a delay between the ultrasonic sound detected by the at least two sound receivers, to drive the sound generator with an electric signal, or to do a combination thereof.

4. The device of claim 1, wherein the ultrasonic sound generated by the sound generator comprises one or more pulses, at least two different frequencies, or both.

5. The device of claim 1, wherein the ultrasonic sound detected by the at least two sound receivers comprises at least a reflected portion, a refracted portion, a diffracted portion or their combination, of the ultrasonic sound generated by the sound generator.

6. The device of claim 1, wherein the sound generator comprises one or more electro dynamic speakers operable to directly generate air movement, or wherein the sound generator comprises one or more piezoelectric speakers.

7. The device of claim 1, wherein the sound generator comprises an organic piezoelectric material, an inorganic piezoelectric material, or both.

8. The device of claim 1, wherein the at least two sound receivers comprise an electret condenser microphone, a microelectromechanical microphone, an ultrasonic transducers comprising a piezoelectric material, or a combination thereof.

9. The device of claim 1, wherein the device comprises a phone, a computer, a tablet, a personal digital assistance (PDA), a television, a computer monitor, a watch, a video game console, a head-mounted display, a wearable electronic device, or a combination thereof.

10. A method of using a device, the device comprising an image display, a sound generator and at least two sound receivers, the method comprising:
generating ultrasonic sound using the sound generator;
detecting reflection, diffraction, refraction or their combination, of the ultrasonic sound, using the at least two sound receivers;
wherein the sound generator is configured to generate audible sound and the at least two sound receivers are configured to detect audible sound.

11. The method of claim 10, wherein the image display, the sound generator and the at least two sound receivers are in a same enclosure of the device.

12. The method of claim 10, further comprising generating audible sound using the sound generator, detecting audible sound using the at least two sound receivers, or both.

13. The method of claim 10, wherein generating ultrasonic sound comprises generating one or more pulses of ultrasonic sound, generating at least two frequencies of ultrasonic sound, or both.

14. The method of claim 10, further comprising determining frequencies, time delay, frequency spectra, waveform of sound detected by the at least two sound receivers.
